(19) United States
(12) Patent Application Publication
(10) Pub. No.: US 2011/0056261 A1
(43) Pub. Date: Mar. 10, 2011

(54) Agronomic Nutrient Production

(76) Inventor: John William Carson, Burton-on-trent (GB)

(21) Appl. No.: 12/747,566

(22) PCT Filed: Dec. 8, 2008
(86) PCT No.: PCT/GB08/51165

§ 371 Date: Oct. 27, 2010

(30) Foreign Application Priority Data
Dec. 13, 2007 (GB) 0724275.3

(51) Int. Cl. C05F 17/00

(52) U.S. Cl. 71/9

(57) ABSTRACT

A process for the conversion of low cost minerals together with proteinaceous wastes and lime based carrier powders, into extended release agronomic nutrifiers containing both fertilisers ingredients and soil pH adjusters, in granulated form. The process comprises aerobic digestion followed by fluid absorption and granulation.

The present invention relates to a process by which agronomic nutrients can be manufactured in extended release form. The process of the present invention and the product obtained thereby provide significant advantages compared with processes and products of the prior art. Examples of such advantages are discussed herein.

According to a first aspect of the present invention, there is provided a process for the manufacture of an agronomic nutrient composition, the process comprising:
(a) effecting the aerobic microbial digestion of a mixture comprising (i) a mineral containing feedstock, (ii) a protein-containing feedstock, and (iii) a digestion accelerant;
(b) absorbing onto a carrier the aerobic digestate obtained in step (a); and
(c) agglomerating the material formed in step (b).

The process defined herein may be applied to a range of low value materials such as combinations of selected minerals and ores together with selected commercial and industrial wastes.

It is a feature of the present invention that the aerobic digestion process is accelerated and made more active so that substances which would not normally digest can be digested by the process defined herein.

The product obtained by the process defined herein is an improved agronomic nutrifier which may contain any or all of the primary nutrients, for example nitrogen, phosphorus and potassium together with secondary and tertiary elements, and, a soil pH controlling agent.

The present invention provides both a convenient form of fertiliser for agriculture and horticulture and an economic form of agronomic nutrification.

Among the advantageous properties the process of the present invention provides a product containing nutrients that last for longer periods than conventional fertilisers, cause less nutrient run-off into surface waters and reduce the need for the liming of soils to regulate their pH.

Whereas it is known that simple agronomic nutrients may be derived via the aerobic or anaerobic digestion of general domestic, commercial and industrial organic wastes, the products produced in liquid slurry form are of low agronomic value.

Moreover even when, as is known to be practiced, these liquid slurry digestates are absorbed onto humic substrates and applied to the land in the form of composts, the nutrient value is still limited.

It has now discovered that nutrifying products of higher agronomic value may be manufactured via the process defined herein.

This discovery has arisen through our on-going research into the acceleration of aerobic digestion processes. Specifically we have now shown through experimentation that substances which would not normally be digested by micro-organisms can now be digested via the process which is the subject of the present invention.

The specific development of microbial digestion which is the subject of the present invention will now be defined:

The present invention specifically involves (in step (a)) aerobic digestion rather than anaerobic digestion.

It has been discovered through our experimentation that the aerobic digestion process is preferable in terms of the manufacture of the proposed improved agronomic nutrifier that is the subject of the present invention.

Aerobic digestion may show several advantages in this context, notably; speed of reaction, reduced ammoniacle generation and improved extraction efficiencies of nutrients derived from substances such as minerals and ores and proteinaceous organic wastes.

In step (a) of the process of the present invention aerobic digestion is preferably carried out in vessels fitted with one or more of stirring devices, aeration systems and steam injection systems.

Such aerobic digestion plants have been previously described and are well known in the waste treatment industry.

To such a manufacturing plant, it is proposed to feed a specific feedstock for the purpose of aerobic digestion. The feedstocks will comprise (i) a mineral containing feedstock, (ii) a protein-containing feedstock, and (iii) a digestion accelerant.

The feedstocks to the aerobic digestion stage (step (a)) will now be further defined:

It is an advantage of the present invention that the feedstocks used comprise low cost minerals and ores and low value difficult to dispose of waste materials.

The feedstock to the aerobic digester comprises a mixture of three components.

The components of the feedstock will firstly be defined separately, however, in practice these components would preferably be added together as a mixed, that is, blended feedstock to the aerobic disgester.

Component (i) is a mineral containing feedstock. This preferably comprises minerals and ores, suitably in finely ground powder form. These minerals and ores may be used to provide, in part, the following elements to the improved agronomic nutrifier being manufactured:
Primary agronomic nutrients: nitrogen, phosphorous, potassium;
Secondary agronomic nutrients: calcium, magnesium, sulphur, iron, carbon;
Tertiary agronomic nutrients: boron plus various transition metals, listed later.

Component (ii) is a protein-containing feedstock. This is preferably selected from animal by-products and/or food industry wastes of a high protein content.

This proteinaceous feed may be used to provide, in part, the following elements to the nutrifier being manufactured:
Primary agronomic nutrients: nitrogen, phosphorous, potassium;
Secondary agronomic nutrients: calcium, iron, carbon.

These proteinaceous materials also constitute the principle microbial feed for the aerobic digestion process.

The third feedstock (component (iii)) added to the aerobic digester, is suitably a secondary microbial feed which acts as a digestion accelerant. This additional feed material may advantageously contain certain sugar sources and polymeric materials, for example gelatines, together with active microbial cultures.

This third feedstock, namely the digestion accelerant, provides some primary, secondary and tertiary nutrients to the feedstock mixture, but, its main function is to stimulate the initial propagation of microbes throughout the aerobic digestion feedstock so as to maximise their effectiveness in the digestion process, and to accelerate that process.

Having defined each of the three components of the aerobic feedstock, we now define a practical approach for the combination of these materials.

We have found it advantageous to pre-blend the first component, that is the minerals and ores of the mineral containing feedstock, with the proteinaceous feed of component (ii)and then add the third component, which is the digestion accelerant, just prior to the feeding of blended feedstock to the digester.

It is a further advantageous embodiment of the present invention that the finely ground minerals and ores may be pre-blended and supplied as a mineral master-batch to be blended into the feedstock mixture as one single addition.

This blending, that is mixing, of the three components produces the feedstock to be aerobically digested.

The feedstock to the aerobic digester may thus contain:
Nitrate ores such as nitratite;
Phosphatic ore such as apatite;
Potassium ore such as feldspar;
Calcium and magnesium mineral such as dolomite;
Sulphur source such as gypsum;
Iron and transition metal sources such as iron ores;
Boron sources such as borax mineral;
Proteinaceous nitrogen sources such as abattoir wastes and selected food industry wastes;
Sugar source such as molasses;
Peptidic source such as gelatine.

The above listing of sources for inclusion in the feedstock to the digester is only by way of examples, alternatives which provide the same or similar nutrificational elements may be substituted.

Various minerals and ores suitable for use in the present invention include those commercially available ground to particle sizes substantially less than 1 mm diameter.

Similarly, the ingredients for the digestion accelerator such as sugar sources and gelatine include those that are commercially available.

The animal by-products and/or food industry wastes used may be selected from those wastes which in the UK are designated Category 3 wastes by the Environment Agency.

These wastes are problematical to the industries from whence they arise because they are generally difficult materials to dispose of effectively and economically.

Such waste materials as those arising at abattoir and or food processing factories are usually in the form of damp mixtures, which are normally difficult to handle. We have discovered that such a arising may be conveniently dust coated with the dry powder master-batch of minerals.

The digestion accelerant may also be combined, by mixing, with the dusted food industry waste, at this stage.

This combined and complete feedstock may then be macerated, via mechanical comminution equipment well known in the industry, to produce a pulp ready for aerobic digestion.

The accelerated aerobic digestion process via which the feedstock pulp is converted into nutrient rich liquid slurry, will now be described.

Whereas equipment for aerobic digestion, in the form of stirred aerated vessels are well known in the industry, we have now discovered improvements to their operation in the treatment of a macerated pulp, for example as described above.

These improvements take the form of additional physico-chemical control methods designed to accelerate the aerobic digestion process.

These improvements will now be defined in three groups associated with:
Process initiation;
Process control; and
Process termination.

Process initiation of the aerobic digestion of the macerated pulp may be advantageous stimulated by any or all of the following methods:

Firstly steam may be used to raise the temperature of the pulp in the reactor, initially from ambient to between 30° C. and 35° C.

Secondly a small proportion of partially digested slurry may be extracted from towards the end of the aerobic digestion process and added to the steamed pulp. This recycling method has the effect of supplying selected micro-organisms to initiate the digestion reaction.

Thirdly we have found that pH is an important factor in the rate of aerobic microbial digestion. Therefore the level of addition of alkaline minerals may be pre-determined so that the digester pH is in the region of 3 to 6.

The above three methodologies have been found to be beneficial, especially when combined, in the initiation stage of the aerobic digestion procedure.

Process control of the aerobic digestion process may be advantageously assisted by any or all of the following methods:

Stirring has the beneficial effect of continually re-contacting microbes with sources of food, which stimulates their propagation and their digestion of the pulp.

Aeration is vital in that the desired reaction is aerobic. Increased aeration may conveniently be used as a method of temperature control during the digestion process. Over rapid digestion temperature rise may be avoided by increased aeration. In this way the digestion process can be controlled towards completion. By driving the reaction towards completion more of the more difficult substances within the pulp will be digested.

Further pH control via the addition of small quantities of acids or alkalis in soluble form may be needed as the digestion process proceeds towards completion. The optimum pH for the continuing process is between 3 and 5.

As completion is approached small quantities of digestate may be removed and recycled to the initiation stage of later batches of pulp.

Once analysis of the digestate indicates that the digestion process is as close to completion as economically desirable then the termination may be initiated.

Process termination of the aerobic digestion stage may advantageously be achieved via the following methodology.

Termination may be effected by gradual reduction in aeration, while stirring continues. The effect will be a rise in digester temperature and a decrease in pH.

The pH of the digested pulp may be allowed to decrease to as low as pH 3.

For full pasteurisation of the digestate it is recommended that a temperature of 70° C. is maintained for four hours.

After full pasteurisation had been achieved the digestate will have assumed the consistency of a hot soup. This digestate may then conveniently be discharged from the aerobic digester.

The final part of this first stage of the manufacturing process may involve the characterisation of the digestate, to check that digestion has approached completeness.

It is a preferred feature of the present invention that the process does not generate wastes, or co-products or by-products. This is to state that all the digestate produced is onward processed into fertiliser. However, it is advantageous if a high proportion of the feedstock has been digested.

The digestate from the aerobic digestion stage, in the form of the hot soup may suitably contain the following pasteurised mixture:
Solubilised primary nutrients, nitrogen, phosphorous, potassium;
Solubilised secondary nutrients, calcium, magnesium, sulphur, iron, carbon;
Solubilised tertiary ingredients, boron plus various transition metals.

Additionally there may be suspended entities and residues derived from the pulp feedstock which contains the same, some or all of the agronomic nutrients listed above. However, these un-digested components are minimised by the modified and accelerated aerobic digestion methodology defined in the present invention.

The physico-chemical mechanism by which otherwise difficult to digest nutrient sources are solubilised is incompletely understood at present, but may be outlined as follows:

It is known that soil based micro-organisms may digest and solubilise small quantities of insoluble minerals and ores, similarly organics such as bone, hoof and horn and other proteinaceous materials. The mechanisms involved are believed to be basically enzymic, however, acidic hydrolysis solubilisation may also be involved. The solubilised products are believed to include complex organic acids and chelates of the dissolved metal ores. The soluble nitrogeneous entities include ureics, amino acids, peptides and protein oligomers. The phosphoric entities include acids and salts, both inorganic and organic. The soluble potassium present will include the chloride and sulphate.

Our understanding of the above reactions remains incomplete but our belief is that the production of solubilised nutrient entities is accelerated by the enzymes generated by the large populations of micro-organisms propagated during our improved version of aerobic digestion, and, the increasing acidity towards the end of the digestion process, maximises solubilities.

Because of the preferred low pH of the digestate towards the end of the aerobic process the majority of the solubilised entities remain in solution or suspension at the end of the digestion stage. Thus the fully digested hot soup at a pH of approximately 3 has the maximum proportion of solubilised agronomic nutrients.

The second stage (step (b)) of the manufacturing process to produce improved agronomic nutrients of the present invention will now be described:

The second stage of the manufacture of improved nutrients is the treatment of the aerobic digestate with a carrier, preferably a reactive carrier powder, that is to say the second stage is a form of fluid absorption.

The nature and choice of reactive carrier powders for this fluid absorption stage, will now be defined:

It is a preferred feature of the present invention that the carrier powder used to convert the aerobic digestate into cake, in preparation for agglomeration into fertiliser, functions in two modes.

The first functional mode of the carrier powder is that it may act as a drying agent. For example the carrier powder added to the soup at the end of the digestion stage is a physico-chemical water entrainment agent.

Our preferred carrier powders function to entrain the aqueous phase of the soup. This is preferably achieved via two mechanisms; they react exothermically with water to produce hydroxide species, and they are highly physically absorbent structures.

The second functionality of our preferred carrier powders is that they contribute to the overall agronomic nutrificational value of the product produced. Preferred carrier powders are liming agents, that is agronomic materials for the control of soil pH.

We have identified a range of preferred carrier powders that perform the dual functionality defined above.

This range of preferred carrier powders include dried, calcined and fired calcium and calcium magnesium minerals, cementitious substances and various industrial process kiln dusts.

Particularly preferred from this range are low cost by-products of the lime and maglime industries and cement kilning operations.

It will be noted that these preferred carrier powders all contain and thus provide lime to the soil when compounded into our improved agronomic nutrifiers. As such they provide the dual function of adding agronomically to the product produced, as well as functioning as driers.

Additional fertiliser ingredients such as dry powders which contain one or more primary nutrification element may conveniently be added along with, that is blended into, the preferred carrier powder.

The method by which the preferred carrier powder and the hot digestate soup are blended into a limed fertiliser cake suitable for agglomeration, will now be described.

We have found it convenient to blend the hot digestate soup with the carrier powder using a rotating vane mixer. Examples of such mixers known in the industry included Hobart dough mixers and Eirich impeller mixers.

The appropriate ratio of soup to carrier powder mix is preferably in the region of one part by weight of each ingredient. However, depending on the consistency of the soup up to three parts by weight of carrier powder may be needed.

With practice it becomes possible to accurately gauge the amount of carrier powder that needs to be added to a particular digestate soup so as to produce a limed fertiliser cake with a consistency suitable for agglomeration.

The method by which the blended digestate soup and the carrier powder, that is the fertiliser cake, is agglomerated will now be described.

What follows is a description of the third and final stage (step (c)) in the manufacturing process for the improved agronomic nutrifier which is the subject of the present invention.

We have found that a limed fertiliser cake, produced according to the current invention may be agglomerated by either granulation or pelletisation.

The preferred route is granulation and within granulation the most preferred equipment used is a dish granulator. There are several well known designs of dish granulator known in the industry, and any of these can be used.

Such a dish granulation process may be aided by the addition of a fine water spray an or a granulation aid, such as a clay and or by the use of a small additional quantity of the carrier powder as a dry surface coating. All these techniques are well known in the industry.

Within the range of available granulation aids a zeolitic or cation retention clay is preferred, as this adds to the overall value of the agronomic product produced. This additional advantage arises through the retention of agronomic nutrients and further extension in their release.

Once the agglomeration step is completed the limed fertiliser granules may be sized and further dried.

It is convenient to size sort the limed fertiliser granules prior to drying so that oversize and undersize material can be returned to the granulation stage.

Any convenient sizing equipment as used in the industry may be employed for this granule sizing task.

The on-size granules may then be dried. It will be noted that a significant proportion of the moisture from the digestate soup will now be chemically bound as hydroxides into the carrier powder, and therefore the necessary amount of evaporate drying is reduced by our process.

The purpose of the drying stage is to increase the stability of the product during storage.

Any convenient type of granule drying equipment, as known and used in the industry, can be employed for the drying stage of the manufacture of granular fertiliser, according to the present invention. Examples of suitable driers include tray driers, rotary driers and fluidised bed driers.

The drying stage completes the third and final stage of the stage manufacturing process for the improved agronomic nutrifier, according to the present invention.

According to a second aspect of the present invention there is provided an agronomic nutrient composition obtained by the process of the first aspect.

The physico-chemical nature of the finished product, from the above process, will now be described:

Physically, the finished product from the manufacturing process, defined herein, is a range of substantially dust free, stable in storage, granular limed extended release nutrifiers.

In a further aspect the present invention provides an agronomic nutrient composition comprising primary nutrients; optionally secondary and/or tertiary nutrients; and a liming agent.

The composition is preferably an extended release composition. Other preferred features of the composition are as described in relation to the first aspect or as subsequently defined herein.

Both straight, that is single nutrient nutrifiers for example nitrogen fertilisers, and compound, that is nutrifiers containing two or more elemental nutrient sources can be made according to the present invention.

Both straight and compound nutrifiers manufactured according to the present invention, are physico-chemical improvements over conventional fertilisers in ways that will now be defined.

It is generally accepted in the agronomic nutrification sector that the chemical nature of the elemental nutrient sources present in a fertiliser, have considerable influence on the overall agronomic value of the fertiliser.

The agronomic nutrient composition may be referred to as a nutrifier or a fertiliser.

Specifically, chemical sources that confer a degree of slower which is to say controlled or extended release, are preferred to fast releasing fertilisers.

This is because extended release provides nutrification to the crop over longer periods during its growth.

Additionally, extended release fertilisers are preferred because less of the nutrients contained in the fertiliser are eluted from the soil during wet weather periods. This is to say that extended release fertilisers produce less nutrient run-off and contamination of surface waters, which in turn pollute rivers and drinking waters.

It will be seen for the above, that extended release fertilisers are advantageous in terms of economics, environment and ecology.

What we have discovered in our development of the improved agronomic nutrifier, which is the subject of the present invention, is that a significant proportion of elemental nutrients contained are present in chemical forms that provide for beneficial extended release.

This provision of nutrients in beneficial forms will now be defined.

The improved agronomic nutrifiers described herein contains a significant proportion of their nitrogen content in the form of protein oligomers peptides and polymeric ureic compounds. These nitrogen sources are known to provide nutrification over extended periods. As such the nitrogen content provided is of higher agronomic value than that provided by conventional inorganic fertilisers.

The improved agronomic nutrifiers as described herein contain a significant proportion of their phosphorus content in the form of organically derived phosphates and partially solubilised mineral sources. These phosphorus sources are known to provide phosphorus nutrification over extended periods. As such the phosphorus content provided is of a higher agronomic value than that provided by conventional inorganic fertilisers.

The improved agronomic nutrifiers as described herein contain a significant proportion of their potassium content in the form of organically derived salts and partially solubilised mineral sources. These potassium sources are known to provide potassium nutrification over extended periods. As such the potassium content provided is of a higher agronomic value than that provided by conventional inorganic fertilisers.

The compound agronomic nutrifiers containing one two or three of the primary nutrients, manufactured according to the present invention, are improvements over conventional fertilisers because of their extended primary nutrient release properties described above.

Moreover they are improvements over conventional fertilisers because of their inclusion of other agronomic nutrients that will now be defined.

The improved agronomic nutrifiers produced may contain, in addition to primary nutrients, up to five secondary elements, these being; calcium, magnesium, sulphur, iron and carbon. Moreover these are preferably provided to the crops in extended release form.

The agronomic nutrifiers produced may contain, in addition to primary and secondary nutrients up to or more than eight tertiary, that is trace elements these being; boron, vanadium, manganese, cobalt, nickel, copper, zinc, and molybdenum. Moreover these are preferably provided to the crops in extended release format.

It will be noted that the presence in the improved agronomic nutrifier of alkaline substances such as calcium hydroxides effects a degree of extended release in terms of these trace element nutrient sources. For example many elemental sources which were soluble in the acidic environment of the digestate soup become insolubilised in the alkaline environment of the limed digestate and subsequently granulated nutrifier.

The improved agronomic nutrifier containing primary, secondary and tertiary elements, is a still further improvement over conventional fertilisers because of their significant alkalinity, which acts as a soil pH control agent.

The improved agronomic nutrifier manufactured according to the present invention, contain significant quantities of liming agents which farmers would otherwise have to apply separately to their soils.

Most agricultural land needs liming periodically so as to restore soil pH to the optimum for crop cultivation. Without lime addition the soil pH progressively falls, which is to say becomes more acidic, to the point where the excess acidity impairs crop growth.

The application of lime to agricultural land constitutes a separate and expensive exercise for farmers.

It will therefore be seen that the presence in the improved agronomic nutrifier of significant quantities of liming agents, constitutes a further agronomic advantage.

The need to separately lime soils may be reduced or even eliminated via the application of the improved agronomic nutrifier defined herein.

Less fertiliser and lime need be applied in the physico-chemical form of the improved agronomic nutrifier described herein, than would be the case if conventional inorganic fertilisers and separate liming were applied.

Moreover, the present invention provides better for soil fertility maintenance than conventional fertilising plus liming.

By applying the improved agronomic nutrifier, which is the subject of the present invention, soil fertility sustainment and conservation may be achieved.

Additionally, the present invention constitutes an environmentally preferable alternative to current disposal systems for problematical animal processing and food industry wastes.

The methods by which the improved agronomic nutrient, defined herein, may be used will now be described.

The improved agronomic nutrifier may be conveniently applied using any conventional granular fertiliser application equipment known within the farming industry.

The combined liming and complete nutrificational function of the improved agronomic nutrifier may be advantageously used in a wide range of agricultural and horticultural farming and growing procedures, which may be exemplified as follows:

The first example is the use of the improved agronomic nutrifier in general arable farming. In such farming circumstances one application of the product of the present invention may provide for all necessary pH control and nutrient requirement for the crop for the whole of the growing season.

The second example is the use of the improved agronomic nutrifier in the farming of wetlands, river margins, sandy and porous land and other circumstances in which nutrient loss through elution may occur. In such farming situations the use of the product of the present invention allows for significantly less fertiliser to be applied that when using conventional inorganic fertilisers.

The third example is the use of the improved agronomic nutrifier in the farming of acidic soils such as fen land, boggy land, land rich in humus, land on acidic strata and land which requires significant liming. In such farming circumstances the use of the product of the present invention allows for the reduction or elimination of the separate application of lime.

The fourth example is the use of the improved agronomic nutrifier in the farming of land with secondary element deficiencies. Such lands include soils deficient in calcium, magnesium, sulphur, iron and available carbon. In such farming situations the use of the product of the present invention allows for the reduction or elimination of the separate application of substances to counter these deficiencies.

The fifth example is the use of the improved agronomic nutrifier in the farming of land with tertiary element deficiencies. Such lands include soils deficient in boron or transition metal elements. In such farming situations the use of the product of the present invention allows for the reduction or elimination of the separate application of substances to counter these deficiencies.

The sixth example is the use of the improved agronomic nutrifier in the farming of crops with extended, that is long, growing seasons. Such crops include subjects sown in autumn and harvested the following summer or autumn, and biennial crops. In such farming situations the use of the product of the present invention allows for the reduction or elimination of the application of further fertilisers during the growing period.

The seventh example is the use of the improved agronomic nutrifier in the farming of permanent pastures, perennial crops, fodder crops, grassland and animal grazing crops. In such farming the use of the product of the present invention allows for the reduction of the number of applications of both lime and fertiliser.

The eighth example is the use of the improved agronomic nutrifier in the horticultural industry. Such horticultural crops as salad crops, vegetables, decorative plants and floral plant, hardy nursery stock and sapling arboreal subjects, may all be so nutrified. In such growing situations the use of the product of the present invention allows for the reduction or elimination of the application of additional lime and or fertilisers during the growing period.

In all the above examples throughout agriculture and horticulture the use of our product may be expected to save consumable costs, application equipment costs, energy and labour costs.

Additionally, in all the above examples throughout agriculture and horticulture the use of our product may be expected to provide stronger growth, healthier growth, faster growth, more sustained growth and higher value crops and grown subjects.

The present invention will now be further described by way of an example only:

For the manufacture of a high nitrogen improved agronomic nutrient, the feedstock to the digester may comprise:
85 parts by weight of abattoir offal;
12 parts by weight of finely divided minerals including:
   5 parts by weight nitratite mineral;
   4 parts by weight of apatite mineral;
   3 parts by weight of felspar mineral;
3 parts by weight of digestion accelerant including:
   1 part by weight sugar;
   1 part by weight gelatine;
   1 part by weight recycled active microbial culture.

To 100 parts by weight of digestate produced is then added by blending with active carrier powder:
110 parts by weight of cement kiln dust.

The resulting limed fertiliser cake is then granulated and dried.

The improved agronomic nutrifier formed may have an analysis as follows:
Nitrogen (N) 8%.
Phosphate (P₂O₅) 3%.
Potash (K₂O) 3%.
Plus secondary and tertiary elements.
Neutralising value 35%.

Ranges of both straight and compound versions of the improved agronomic nutrifier may be made by careful selection and portioning of raw materials into the digestate and the active carrier powder.

By careful choice various ratios of primary nutrients may be provided to suit the cultivation of a wide range of both agricultural and horticultural crops.

In all cases the improved agronomic nutrifier produced, according to the present invention, will provide significant economic, environmental and ecological advantages both in terms of the farming and waste management applications. For example the process of the present invention provides an economic and environmentally sound method for the disposal of otherwise problematical wastes.

Taken together the above advantages constitute a significant techno-commercial improvement in the manufacture of agronomic nutrients.

1-12. (canceled)

13. A process for the manufacture of an agronomic nutrient composition, the process comprising:
effecting aerobic microbial digestion of a mixture comprising a mineral containing feedstock, a protein-containing feedstock, and a digestion accelerant so as to obtain an aerobic digestate, wherein the aerobic microbial digestion is carried out at a pH of between 3 and 6;
absorbing onto a carrier the aerobic digestate so as to form a material; and
agglomerating the material.

14. A process according to claim 13, wherein the mineral-containing feedstock comprises ground minerals, and the protein-containing feedstock comprises animal by-products and/or food wastes.

15. A process according to claim 14, wherein the aerobic digestion is carried out at a temperature of between 30 and 35° C.

16. A process according to claim 15, further comprising, at the end of the microbial digestion, pasteurizing the aerobic digestate.

17. A process according to claim 16, wherein the carrier comprises a reactive carrier powder selected from the group consisting of dried, calcined and fired calcium and calcium magnesium minerals, cementitious substances and industrial process kiln dusts.

18. A process according to claim 17, wherein said agglomerating comprises granulating the material using a dish granulator.

19. A process according to claim 13, wherein the carrier comprises a reactive carrier powder selected from the group consisting of dried, calcined and fired calcium and calcium magnesium minerals, cementitious substances and industrial process kiln dusts.

20. A process according to claim 13, wherein the aerobic digestion is carried out at a temperature of between 30 and 35° C.

21. A process according to claim 20, further comprising, at the end of the microbial digestion, pasteurizing the aerobic digestate.

22. A process according to claim 21, wherein the carrier comprises a reactive carrier powder selected from the group consisting of dried, calcined and fired calcium and calcium magnesium minerals, cementitious substances and industrial process kiln dusts.

23. A process according to claim 13, further comprising, at the end of the microbial digestion, pasteurizing the aerobic digestate.

24. A process according to claim 23, wherein the aerobic digestion is carried out at a temperature of between 30 and 35° C.

25. A process according to claim 24, wherein said agglomerating comprises granulating the material using a dish granulator.

26. A process according to claim 25, wherein the carrier comprises a reactive carrier powder selected from the group consisting of dried, calcined and fired calcium and calcium magnesium minerals, cementitious substances and industrial process kiln dusts.

27. A process according to claim 13, wherein said agglomerating comprises granulating the material using a dish granulator.

28. A process according to claim 27, wherein the aerobic digestion is carried out at a temperature of between 30 and 35° C.

29. A process according to claim 28, further comprising, at the end of the microbial digestion, pasteurizing the aerobic digestate.

30. An agronomic nutrient composition obtained by the process of claim 13.

31. An agronomic nutrient composition comprising primary nutrients; optionally secondary and/or tertiary nutrients; and a liming agent.

32. An agronomic composition according to claim 31, wherein the agronomic nutrient composition is an extended release composition.
